(19) United States
(12) Patent Application Publication
(10) Pub. No.: US 2025/0064088 A1
(43) Pub. Date: Feb. 27, 2025

(54) Shelf-Stable and Flexible Pet Treat Item

(71) Applicant: Blue Buffalo Enterprises, Inc., Wilton, CT (US)

(72) Inventors: Aaron Amdor, Delano, MN (US); Natasha Weatherby, Minneapolis, MN (US)

(73) Assignee: Blue Buffalo Enterprises, Inc., Wilton, CT (US)

(21) Appl. No.: 18/719,044

(22) PCT Filed: Feb. 7, 2023
(86) PCT No.: PCT/US2023/012479

§ 371 Date: Jun. 12, 2024

Related U.S. Application Data
(60) Provisional application No. 63/309,845, filed on Feb. 14, 2022.

(51) Int. Cl. A23K 10/20; A23K 20/105; A23K 20/147; A23K 40/25; A23K 50/42

(52) U.S. Cl. CPC A23K 10/20; A23K 20/105; A23K 20/147; A23K 40/25; A23K 50/42

(57) ABSTRACT

A pet treat item formed from shelf-stable pet treat material that enables the pet treat item to be shelf-stable and flexible and therefore well-liked by consumers. The pet treat item remains pliable at room temperature over many months and can be formed from ingredients including tallow, meat, gelatin, glycerin, egg, starches and rice flour. Preferably, the pet treat material includes at least 25% by weight animal fat (e.g., tallow). The item can be in the form of a strip that is malleable and fruit leather-like in texture and that can optionally be formed into a roll or coil. A user could fold or wrap the strip around a veterinary medication to camouflage the medication. The pet treat item can take on alternative forms, e.g., a rope, and/or can be filled. A method of making the pet treat item includes forming a shelf-stable pet treat material into the pet treat item.

### BACKGROUND

Pet owners enjoy feeding treats to their pets to show affection, create interactive moments with their pets, or reward their pets. As consumers are increasingly treating their pets like family members, pet foods/treats that help create unique and enjoyable experiences for pet parents to share with their pets are needed.

### SUMMARY

Described herein is a new pet treat designed to meet pet needs while also providing an enjoyable experience for pet owners. More specifically, the invention concerns providing a shelf-stable and flexible pet treat item formed from a shelf-stable pet treat material. In a preferred embodiment, the pet treat item is a strip having a length, a width and a thickness. The strip is shelf-stable, malleable, and fruit leather-like in texture and is formed using sheeting rollers or by other means (e.g., extrusion through a die). In use, pet owners could, e.g., fold or wrap the strip around a veterinary medication (e.g., a pill) to camouflage the medication from the pet's notice. In one embodiment, the strip is rolled into a roll or coil to form a shelf-stable rolled pet treat item. In other embodiments, the shelf-stable and flexible pet treat item can take on alternative forms (e.g., a rope) and/or can be filled.

The shelf-stable pet treat item remains pliable at room temperature over several months and can be formed from ingredients including animal fat (e.g., beef tallow), meat (e.g., chicken powder/dried chicken), gelatin, glycerin, egg (e.g., egg white), starches and rice flour. In a preferred embodiment, the shelf-stable pet treat material includes at least 15% by weight water and at least 10% by weight gelatin (more preferably, at least 15% by weight gelatin). In another preferred embodiment, the shelf-stable pet treat material includes at least 25% by weight animal fat (e.g., tallow) and, more preferably, at least 40% by weight animal fat (e.g., tallow). The shelf-stable pet treat material enables the resulting pet treat item to be shelf-stable and flexible and therefore well-liked by users (e.g., pet owners).

As mentioned above, in one embodiment, the shelf-stable pet treat item is filled. For example, where the shelf-stable pet treat item is in the form of a strip, the strip includes an outer shell and an inner filling. The strip with the outer shell and the inner filling is preferably formed via a co-extrusion process. The compositions of the outer shell and the inner filling are configured to provide the strip with malleability and allow the strip to be rolled to form a filled and rolled pet treat item. Preferably, the outer shell and the inner filling have differing compositions.

In another embodiment, where the shelf-stable pet treat item is in the form of a strip, the strip of shelf-stable pet treat material is supported upon a support strip. The support strip has the necessary strength to support the pet treat strip without tearing and without bulkiness to allow rolling of the pet treat strip and support strip together into a compact shelf-stable rolled pet treat item and allowing the pet treat strip to be easily separated therefrom during use.

A method of making a shelf-stable pet treat item is also provided herein. A shelf-stable pet treat material is provided and then formed into the shelf-stable pet treat item. In a preferred embodiment, the method includes providing a shelf-stable pet treat material and forming the shelf-stable pet treat material into a strip having a thickness, a width and a length. In certain embodiments, forming the shelf-stable pet treat material into the strip includes feeding the shelf-stable pet treat material to a pair of sheeting rollers. In another embodiment, forming the shelf-stable pet treat material into the strip further includes feeding a strip of support material to the pair of sheeting rollers simultaneously with the shelf-stable pet treat material. Alternatively, the pet treat material is formed into the strip via extrusion through a die (e.g., co-extrusion to create an outer shell and an inner filling). In either case, the formed strip of shelf-stable pet treat material can then optionally be rolled into a roll or coil to form a shelf-stable rolled pet treat item.

A shelf-stable pet treat item provided herein can be packaged after manufacture using any appropriate equipment and packaging and can have a shelf life at room temperature of at least 6 months, preferably at least 9 months, and more preferably at least 12 months, where the pet treat maintains a substantially stable appearance, pliability and pet palatability.

### BRIEF DESCRIPTION OF THE DRAWINGS

FIG. 1 shows a perspective view of an embodiment of a shelf-stable pet treat item of the present invention in the form of a rolled pet treat item.

FIG. 2 shows a perspective view of an embodiment of a shelf-stable pet treat item of the present invention in the form of a strip of shelf-stable pet treat material.

FIG. 3 shows a perspective view of another embodiment of a shelf-stable pet treat item of the present invention in the form of a filled and rolled pet treat item.

FIG. 4 shows a perspective view of another embodiment of a shelf-stable pet treat item of the present invention in the form of a filled strip of shelf-stable pet treat material, having an outer shell and an inner filling.

FIG. 5 shows a perspective view of a shelf-stable pet treat item of the present invention in the form of a roll having a support strip.

FIG. 6 shows a perspective view of a shelf-stable pet treat item of the present invention in the form of a strip of shelf-stable pet treat material supported upon a support strip.

FIG. 7 shows a partial diagrammatic side view of an apparatus for making a shelf-stable pet treat item in accordance with the present invention.

FIGS. 8 and 9 show perspective views of a veterinary medication being placed upon and wrapped within a shelf-stable pet treat item of the present invention.

FIG. 10 shows a perspective view of an embodiment of a shelf-stable pet treat item of the present invention in the form of a rope of shelf-stable pet treat material.

### DETAILED DESCRIPTION

Consumers are increasingly embracing the role pets play in their families. Such consumers, sometimes referred to as “pet parents,” look for ways to meet the needs of their pets while also treating them as though they are full members of their family. In addition to regular food, pet parents enjoy feeding their pets treats to show affection, to create interactive moments with their pets, or to reward their pets.

Although many pets enjoy foods designed for human consumption, most pet foods, including treats, are more suitably formulated to meet the preferred tastes and/or nutritional needs of pets. One challenge in producing pet foods is to make the foods enticing to pets while also providing pet foods that help create unique and enjoyable experiences for pet parents to share with their pets.

Described herein is a new pet treat designed to meet pet needs while also providing an enjoyable experience for pet parents. In a preferred embodiment, the pet treat item provided herein is uniquely developed to resemble a Fruit by the Foot™ product, which is a novelty food item suitable for human consumption. In particular, the Fruit by the Foot™ product is a fruit-based snack wherein a thin strip of fruit-based material is supported upon a support strip and rolled into a coil. Surprisingly, a shelf-stable rolled pet treat item reminiscent of a Fruit by the Foot™ product can be formed from high quality natural ingredients, such as animal fat (e.g., tallow), meat and eggs. The shelf-stable pet treat item remains soft and malleable over many months of ambient storage.

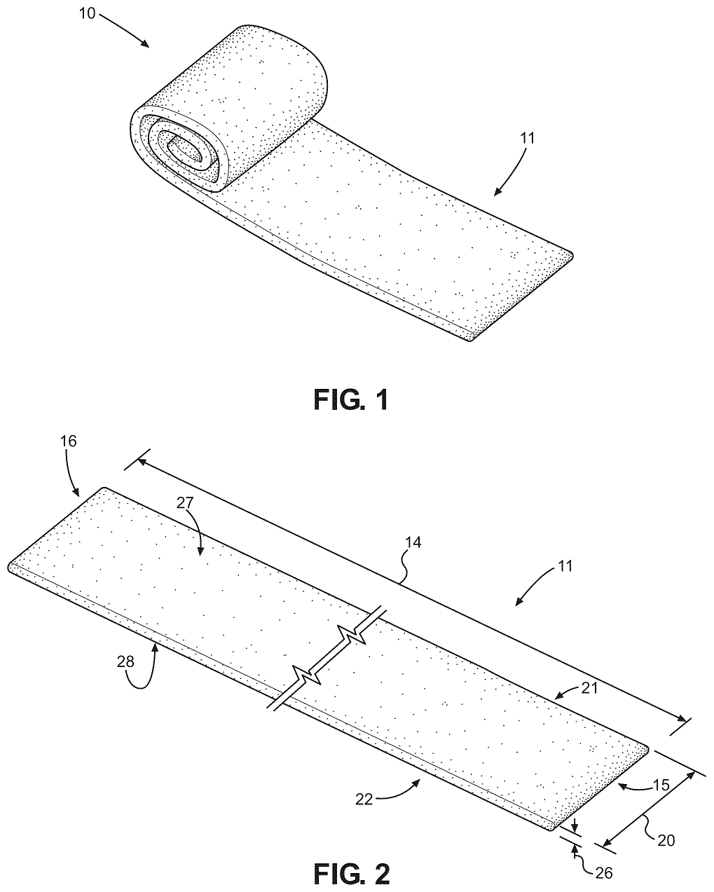

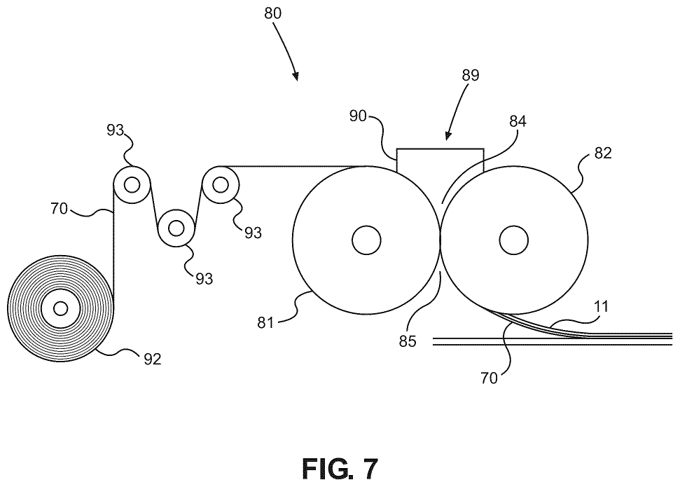

A shelf-stable pet treat item according to the preferred embodiment of the present invention is shown at 10 in FIG. 1 in a partially rolled form. Shelf-stable rolled pet treat item 10 is formed from a strip 11 of shelf-stable pet treat material. As best shown in FIG. 2, strip 11 has a length 14 between a leading end 15 and a trailing end 16, a width 20 between a first edge 21 and a second edge 22, and a thickness 26 between a top surface 27 and a bottom surface 28. The break lines shown in FIG. 2 indicate that length 14 of strip 11 can vary. Although not similarly shown, the width and thickness can also vary. Strip 11 can be formed using sheeting rollers as described further below with reference to FIG. 7. However, strip 11 could also be formed by other means, e.g., extrusion through a die. In any case, strip 11 is rolled into a roll or coil to form shelf-stable rolled pet treat item 10.

Strip 11 is shelf-stable, malleable, and leather-like in texture. As indicated above, strip 11 can be formed from various ingredients, including animal fat (e.g., beef tallow), meat (e.g., chicken powder/dried chicken), gelatin, glycerin, egg (e.g., egg white), starches and rice flour. In a preferred embodiment, the shelf-stable pet treat material includes at least 15% by weight water and at least 10% by weight gelatin (more preferably, at least 15% by weight gelatin). In another preferred embodiment, the shelf-stable pet treat material includes at least 25% by weight animal fat (e.g., tallow) and, more preferably, at least 40% by weight animal fat (e.g., tallow). The compositions of the shelf-stable pet material used to form strip 11 is configured to provide strip 11 with malleability and allow strip 11 to be rolled to form rolled pet treat item 10. Table 1 shows an exemplary formulation for the shelf-stable pet treat material. The formulation of Table 1 is, however, not limited to use in forming only the strip embodiment of the invention.

TABLE 1

| Ingredient | % by weight |
|---|---|
| Water | 0-25 |
| Glycerin | 10-25 |
| Animal fat (e.g., tallow) | 35-65 |
| Gelatin | 12-22 |
| Meat (e.g., dried chicken) | 2-26 |
| Egg (e.g., egg white) | 1-10 |
| Rice flour | 3-15 |
| Natural flavor | 0-5 |

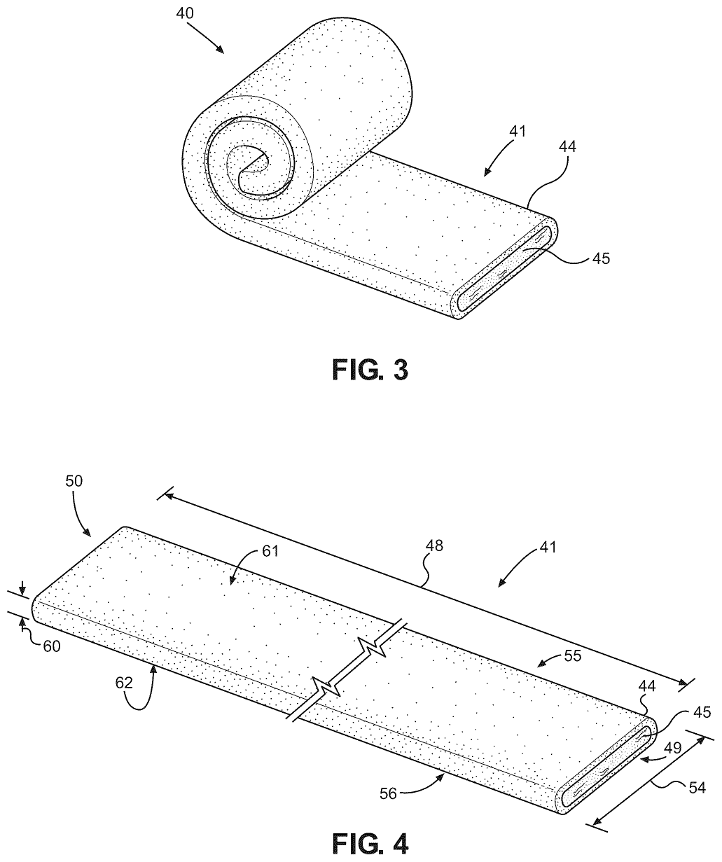

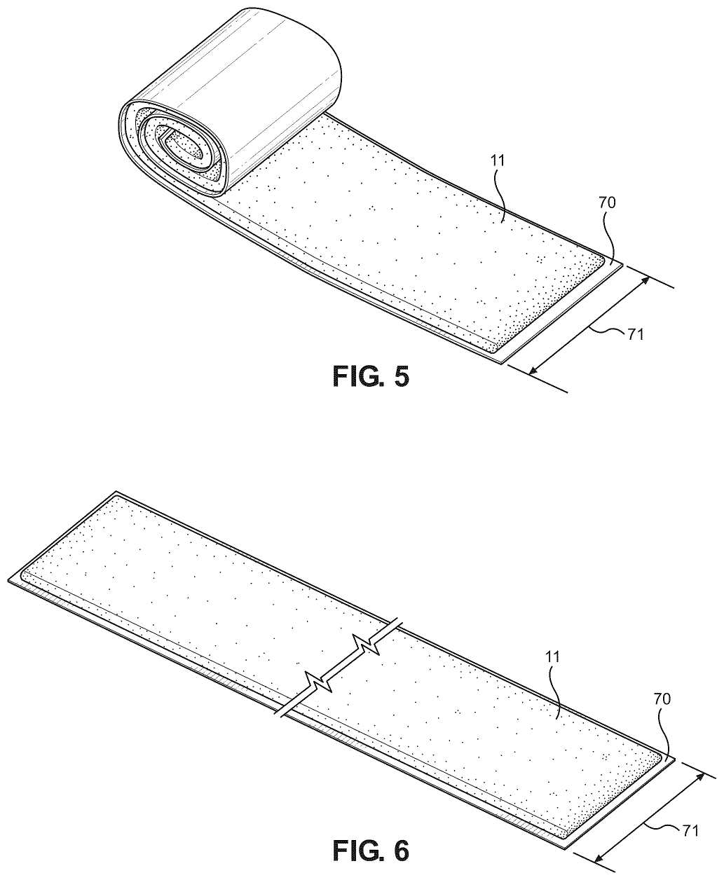

In an alternative embodiment, as shown in FIG. 3, the shelf-stable rolled pet item includes an inner filling. More specifically, a shelf-stable filled and rolled pet treat item 40 is formed from a strip 41 of shelf-stable material that includes an outer shell 44 and an inner filling 45. As best shown in FIG. 4, strip 41 has a length 48 between a leading end 49 and a trailing end 50, a width 54 between a first edge 55 and a second edge 56, and a thickness 60 between a top surface 61 and a bottom surface 62. The break lines shown in FIG. 4 indicate that length 48 of strip 41 can vary, while the same is true for the width and thickness. Strip 41 is preferably formed via a co-extrusion process and then rolled into a roll or coil to form shelf-stable rolled pet treat item.

Like strip 11, strip 41 is shelf-stable and malleable. In particular, strip 41 remains pliable at room temperature over many months. Strip 41, including outer shell 44 and/or inner filling 45 thereof, can be formed from various ingredients, with outer shell 44 preferably having a composition directly corresponding to strip 11 such that Table 1 above shows an exemplary formulation for the outer shell of this shelf-stable pet treat. Further like strip 11, the compositions of outer shell 44 and inner filling 45 are configured to provide strip 41 with malleability and allow strip 41 to be rolled to form filled and rolled pet treat item 40. Preferably, outer shell 44 and inner filling 45 have differing compositions. In some embodiments, inner filling 45 could be an edible material that is potentially more enticing to pets than outer shell 44 (e.g., peanut butter-flavored).

Each of strips 11 and 41 can be supported on a support strip prior to use. By way of example, FIGS. 5 and 6 depict strip 11 supported upon a support strip 70. In one embodiment, strip 11 is of a thinness generally requiring external support. However, other circumstances may warrant support strip 70 being necessary and/or desirable. Support strip 70 may be formed of any suitable material, such as silicon parchment paper, which has the necessary strength to support pet treat strip 11 without tearing and without bulkiness to allow rolling of pet treat strip 11 and support strip 70 into an overall compact shelf-stable rolled pet treat item and which allows pet treat strip 11 to be easily separated therefrom during use. As shown, support strip 70 has a width 71 that is larger than the width of strip 11. Although width 71 can be equal to the width of strip 11, width 71 is preferably not smaller than the width of strip 11. Similar to that set forth above, the break lines shown in FIG. 6 indicate that the length of strip 11 upon support strip 70 can vary. Again, although not shown, strip 41, which forms filled and rolled pet treat item 40, can be similarly supported upon a support strip.

A method of making a shelf-stable rolled pet treat item is also provided herein, with the method including providing a shelf-stable pet treat material and forming the shelf-stable pet treat material into a strip having a thickness, a width and a length. FIG. 7 shows a partial diagrammatic side view of an exemplary apparatus 80 for making a shelf-stable rolled pet treat item of the present invention. As depicted, apparatus 80 constitutes a strip sheeter generally including first and second press rollers 81 and 82. Rollers 81 and 82 are rotated in opposite rotational directions to define an upper, mating side 84 and a lower, exit side 85. Pet treat material is heated to a temperature to become flowable or pumpable and is filled into upper mating side 84. A containment bin or saddle 89, having a cross bar 90, is provided complementary to and for holding the pet treat material above and evenly feeding to and within mating side 84. Support strip 70 is supplied from a roll 92 and, after extending around tension rollers 93, is directed under cross bar 90 of saddle 89 and then to between rollers 81 and 82 into exit side 85. The pet treat material is initially located in mating side 84 intermediate support strip 70 and second roller 82. It can then be appreciated that, as the pet treat material and support strip 70 are pulled between rollers 81 and 82 by the rotation of rollers 81 and 82, the material and support strip 70 advancing between rollers 81 and 82 will be compressed such that the material will be deposited as a continuous strip 11 upon support strip 70. Alternatively, the pet treat material can be formed into the strip via extrusion through a die (co-extrusion to create an outer shell and an inner filling). The formed strip of shelf-stable pet treat material is cut to length, then rolled into a roll or coil to form the shelf-stable rolled pet treat item.

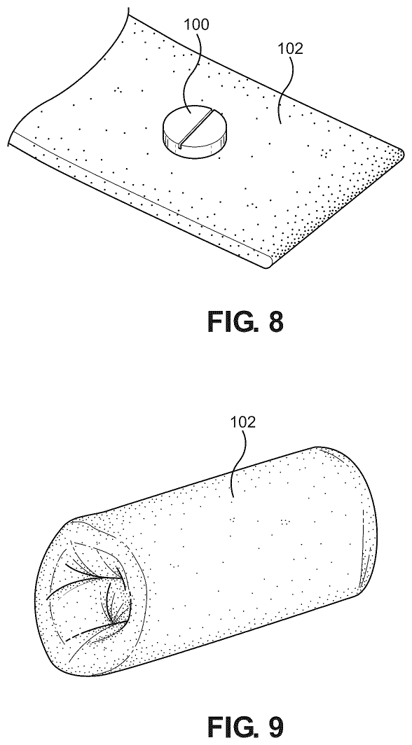

In an embodiment, in use, the shelf-stable pet treat item of the present invention can be wrapped around a veterinary medication to camouflage the medication from the pet's notice. See for example in FIGS. 8 and 9 a medication pill 100 being placed upon and wrapped within a shelf-stable pet treat item 102 in a form suitable for wrapping (e.g., a piece of a strip of the shelf-stable pet treat material).

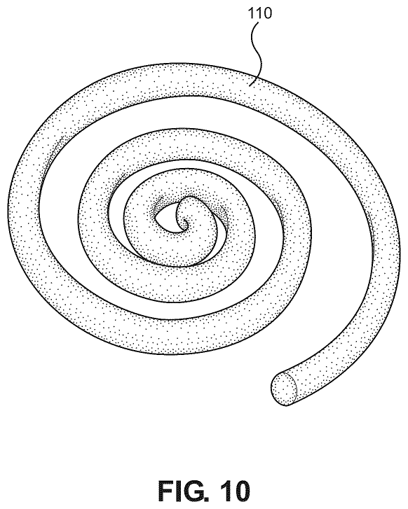

Although previously described mostly with reference to the preferred strip/rolled strip embodiments of the invention, the shelf-stable pet treat according to the present invention can take on alternative forms, which may optionally be filled (e.g., have an inner filling). For example, as shown in FIG. 10, the shelf-stable pet treat may be in the form a rope 110 (e.g., similar to a licorice rope). Rope 110 can optionally be filled (e.g., have an inner filling).

After being produced, the shelf-stable pet treat item can be packaged using any appropriate equipment and packaging. In particular, the shelf-stable pet treat items can be packaged with multiple pieces in a single package or packaged individually. In some embodiments, individual shelf-stable pet treat item provided herein can be wrapped, then individually wrapped pieces can be packaged together for sale.

A shelf-stable pet treat item described herein can have a shelf life at room temperature of at least 6 months, preferably at least 9 months and even at least 12 months, where the pet treat maintains a substantially stable appearance, pliability and pet palatability.

Although described with reference to certain embodiments of the invention, one skilled in the art will appreciate that the present disclosure can be practiced with embodiments other than those disclosed and that the disclosed embodiments are presented for purposes of illustration and not limitation.

1. A shelf-stable and flexible pet treat item comprising a shelf-stable pet treat material, wherein the shelf-stable pet treat material includes at least 25% by weight animal fat, at least 15% by weight water and at least 10% by weight gelatin.

2. The shelf-stable and flexible pet treat item of claim 1, wherein the shelf-stable pet treat material further includes glycerin.

3. The shelf-stable and flexible pet treat item of claim 2, wherein the shelf-stable pet treat material includes at least 40% by weight animal fat.

4. The shelf-stable and flexible pet treat item of claim 1, wherein the shelf-stable and flexible pet treat item is a strip of shelf-stable pet treat material having a top surface and a bottom surface, a thickness defined between the top surface and the bottom surface, a first edge and a second edge, a width defined between the first edge and the second edge, a leading end and a trailing end and a length defined between the leading end and the trailing end and wherein the strip of shelf-stable pet treat material is rolled into a roll.

5. The shelf-stable and flexible pet treat item of claim 4, wherein the strip comprises an outer shell and an inner filling distinct from the outer shell.

6. The shelf-stable and flexible pet treat item of claim 5, wherein the inner filling is peanut butter flavored.

7. The shelf-stable and flexible pet treat item of claim 4, further comprising a strip of support material upon which the strip of shelf-stable pet material is supported.

8. The shelf-stable and flexible pet treat item of claim 7, wherein the support material has a width greater than the width of the strip of shelf-stable pet material.

9. The shelf-stable and flexible pet treat item of claim 1, wherein the shelf-stable and flexible pet treat item has pliability and pet palatability.

10. The shelf-stable and flexible pet treat item of claim 9, wherein the shelf-stable and flexible pet treat item has a shelf life of at least 6 months.

11. The shelf-stable and flexible pet treat item of claim 10, wherein the shelf-stable and flexible pet treat item has a shelf life of at least 12 months.

12. The shelf-stable and flexible pet treat item of claim 1, wherein the shelf-stable and flexible pet treat item is a rope.

13. A method of producing a shelf-stable and flexible pet treat item, the method comprising:
providing a shelf-stable pet treat material, wherein the shelf-stable pet treat material comprises at least 25% by weight animal fat, at least 15% by weight water and at least 10% by weight gelatin; and
forming the shelf-stable pet treat material into the shelf-stable and flexible pet treat item.

14. The method of claim 13, wherein the shelf-stable pet treat material further includes glycerin.

15. The method of claim 14, wherein the shelf-stable pet treat material includes at least 40% by weight animal fat.

16. The method of claim 13, wherein forming the shelf-stable pet treat material into the shelf-stable and flexible pet treat item includes forming the shelf-stable pet treat material into a strip having a top surface and a bottom surface, a thickness defined between the top surface and the bottom surface, a first edge and a second edge, a width defined between the first edge and the second edge, a leading end and a trailing end and a length defined between the leading end and the trailing end.

17. The method of claim 16, further comprising rolling the strip of shelf-stable pet treat material to form a rolled pet treat.

18. The method of claim 16, wherein forming the shelf-stable pet treat material into the strip includes feeding the shelf-stable pet treat material to a pair of sheeting rollers.

19. The method of claim 18, wherein forming the shelf-stable pet treat material into the strip further includes feeding a support material to the pair of sheeting rollers simultaneously with the shelf-stable pet treat material, resulting in the strip of shelf-stable pet treat material being arranged atop the support material.

20. The method of claim 13, wherein forming the shelf-stable pet treat material into the shelf-stable and flexible pet treat item includes forming the shelf-stable pet treat material into a rope.
